(19) United States
(12) Patent Application Publication
(10) Pub. No.: US 2006/0235665 A1
(43) Pub. Date: Oct. 19, 2006

(54) Methods and systems for operating engine cycle models

(75) Inventors: Daniel Robert Dwyer, West Chester, OH (US); Lorenzo Escriche, Ross Township, OH (US); John Thomas Goodall, Cincinnati, OH (US); Arlie Russell Martin, Acworth, GA (US)

Correspondence Address: JOHN S. BEULICK (12729);C/O ARMSTRONG TEASDALE LLP, ONE METROPOLITAN SQUARE, SUITE 2600, ST. LOUIS, MO, 63102-2740, US

(73) Assignee: GENERAL ELECTRIC COMPANY

(21) Appl. No.: 11/109,431

(22) Filed: Apr. 19, 2005

(51) Int. Cl. G06G 7/48

(52) U.S. Cl. 703/7

(57) ABSTRACT

A computer-implemented tool and method of operating a calculational model is provided. The method includes selecting a model from a predetermined plurality of available models, entering input data corresponding to preformatted data entry fields that are predetermined for the selected model, converting the entered input data to a predetermined format corresponding to the selected model, and determining, using the selected model, a model result corresponding to the converted input data and the selected model.

### BACKGROUND OF THE INVENTION

This invention relates generally to thermodynamic cycle models, and more particularly to methods and systems for operating gas turbine engine cycle models.

At least some known cycle models are detailed and complex to an extent that makes operating them impractical for most users. Significant expertise and/or training may be required to operate cycle models proficiently. A user that manages a plurality of models for a plurality of different pieces of equipment may require a significant staff and resources to manage the models to accomplish a business goal. Operating complex models may be a time-consuming process that requires considerable expertise. For example, an applications engineer may have the knowledge to operate a particular model, but may not have the knowledge to operate a model used to simulate a different piece of equipment or a model that operates on a different platform. The expertise of the applications engineer may have been acquired as the result of many years of training and experience in a wide variety of situations. Additionally, lesser trained individuals that may have a need to generate results from a model may not be able to use a model to generate accurate results at all. Therefore, a proficient individual, such as the applications engineer, may be needed to operate the model for the lesser trained individual. However, having a suite of available models that require specialized knowledge to operate may not be cost-effective and efficient use of available resources.

### BRIEF DESCRIPTION OF THE INVENTION

In one aspect, a computer-implemented method of operating a calculational model is provided. The method includes selecting a model from a predetermined plurality of available models, entering input data corresponding to preformatted data entry fields that are predetermined for the selected model, converting the entered input data to a predetermined format corresponding to the selected model, and determining, using the selected model, a model result corresponding to the converted input data and the selected model.

In another aspect, a calculational model operation tool is provided. The tool includes a user interface configured to display a preformatted data entry screen corresponding to user input selections, said user interface programmed to receive data input by a user, and a processor programmed to format input data received from the user interface into a configuration format corresponding to a selected model, said processor further programmed to execute the selected model using the input data in the configuration format.

In yet another aspect, a computer program embodied on a computer readable medium for operating a calculational model using a server system coupled to a client system and a database wherein the client system includes a user interface is provided. The program includes a code segment that prompts a user to select at least one model and then selects a model from a predetermined plurality of available models, receives input data corresponding to preformatted data entry fields that are predetermined for the selected model, converts the entered input data to a predetermined format corresponding to the selected model, and determines, using the selected model, a model result corresponding to the converted input data and the selected model.

### BRIEF DESCRIPTION OF THE DRAWINGS

FIG. 1 is a schematic diagram of a portion of a web-based engine cycle model operation tool embodied in a general-purpose computer system;

FIG. 2 is a data flow diagram of an exemplary embodiment of an architecture for the web-based engine cycle model operation tool shown in FIG. 1;

FIG. 3 is an example embodiment of a user interface displaying an entry screen for a web-based cycle model operation tool;

FIG. 4 is an example embodiment of the user interface, shown in FIG. 3, displaying input data that has been at least partially formatted for transmitting to model in a display window;

FIG. 5 is an example embodiment of the user interface displaying a formatted data file that includes a documentary section, a model execution section, an engine configuration section, and an output section; and

FIG. 6 is a flow chart of an exemplary computer-implemented method of operating a calculational model.

### DETAILED DESCRIPTION OF THE INVENTION

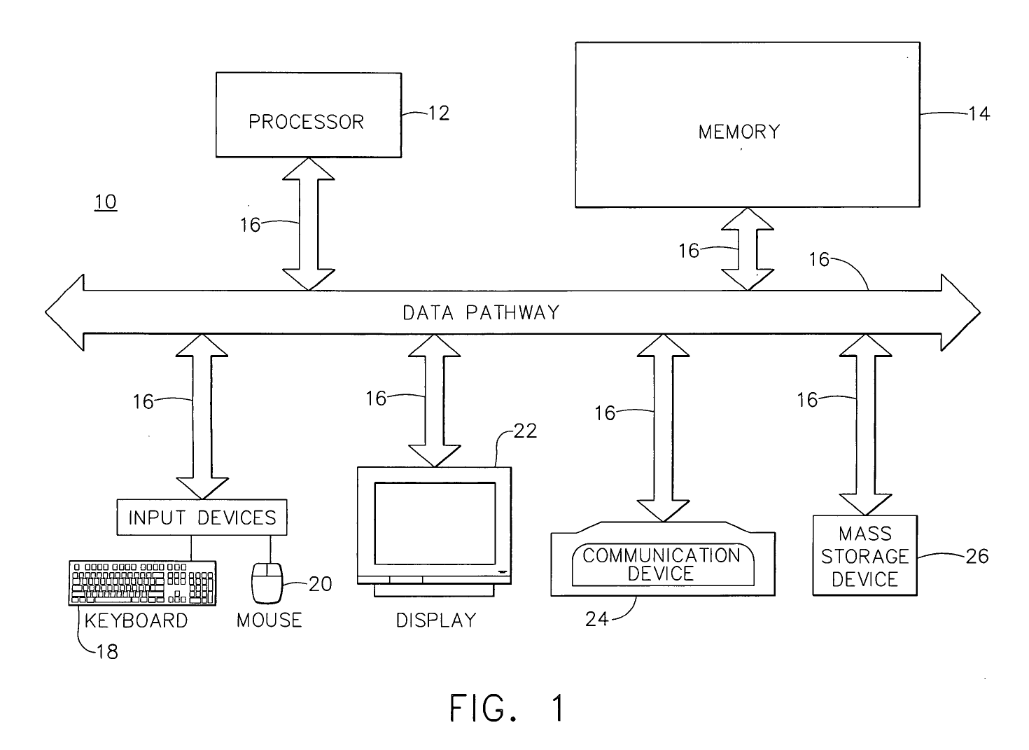

FIG. 1 is a schematic diagram of a portion of a web-based engine cycle model operation tool embodied in a general-purpose computer system 10. Computer system 10 generally comprises a processor 12, memory 14, input/output devices, and data pathways (e.g., buses) 16 connecting the processor, memory and input/output devices. Processor 12 receives instructions and data from memory 14 and performs various operations. Processor 12 includes an arithmetic logic unit (ALU) that performs arithmetic and logical operations and a control unit that extracts instructions from memory 14 and decodes and executes them, calling on the ALU when necessary. Memory 14 generally includes a random-access memory (RAM) and a read-only memory (ROM), however, there may be other types of memory such as programmable read-only memory (PROM), erasable programmable read-only memory (EPROM) and electrically erasable programmable read-only memory (EEPROM). Also, memory 14 preferably contains an operating system, which executes on processor 12. The operating system performs basic tasks that include recognizing input, sending output to output devices, keeping track of files and directories and controlling various peripheral devices.

The input/output devices may include a keyboard 18 and a mouse 20 that may be used to enter data and instructions into computer system 10. Also, a display 22 may be used to allow a user to see what the computer has accomplished. Other output devices may include a printer, plotter, synthesizer, and speakers. A communication device 24 such as a telephone or cable modem or a network card such as an Ethernet adapter, local area network (LAN) adapter, integrated services digital network (ISDN) adapter, Digital Subscriber Line (DSL) adapter or wireless access card, enables computer system 10 to access other computers and resources on a network such as a LAN, wireless LAN and/or wide area network (WAN). A mass storage device 26 may be used to allow the computer system 10 to permanently retain large amounts of data. Mass storage device 26 may include all types of disk drives such as floppy disks, hard disks and optical disks, as well as tape drives that can read and write data onto a tape that could include digital audio tapes (DAT), digital linear tapes (DLT), or other magnetically coded media. The above-described computer system 10 can take the form of a hand-held digital computer, personal digital assistant computer, notebook computer, personal computer, workstation, mini-computer, mainframe computer, or supercomputer.

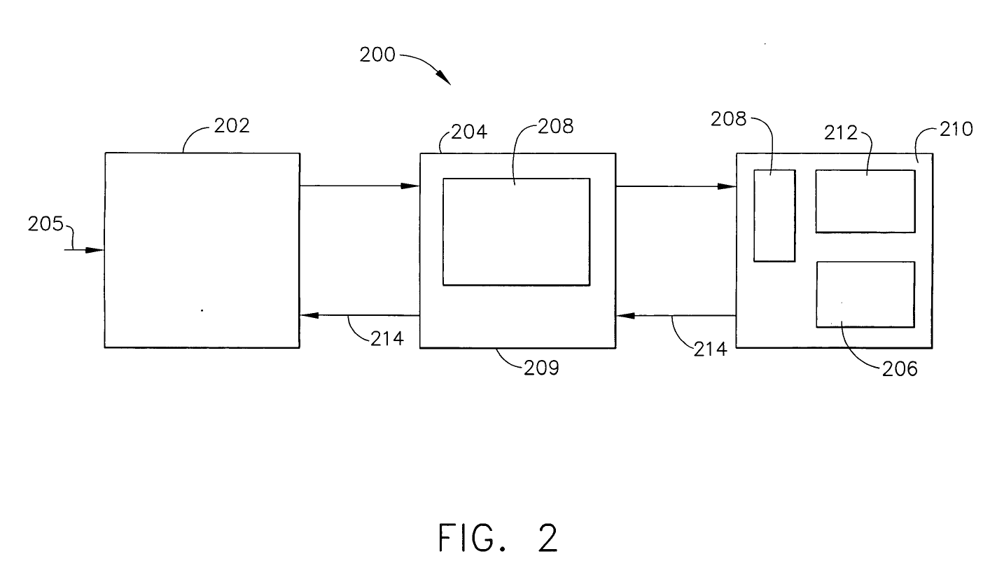

FIG. 2 is a data flow diagram of an exemplary embodiment of an architecture 200 for the web-based engine cycle model operation tool (shown in FIG. 1). Architecture 200 includes an interface 202 executing within an engine cycle model operation tool 204. In the exemplary embodiment, interface 202 is a web-based interface. Tool 204 may operate on a PC-based computer platform or may operate on a client in a client server network arrangement. Tool 204 may also be configured to operate on a handheld PC, PDA and/or other computing device. Tool 204 may receive input data 205 through interface 202 in a predetermined format from a user that is not an expert in the field of cycle modeling. Generally, cycle models include a plurality of algorithms that are conditionally called to determine an engine's simulated response to input data 205 selected to simulate an environment and operating regime desired to be modeled. Sophisticated models may require a significant amount of input data 205 and/or configuration settings to accurately duplicate an engine's performance for a given set of conditions. Managing the data may require specialized knowledge of the model and it's components as well as significant experience with actual engine operation before accurate simulation results may be generated. In the exemplary embodiment, tool 204 prompts a non-expert user to enter input data 205 that corresponds to a model 206 selected from a plurality of available models and accepts only data that is deemed reasonable by limit tests on input data 205. Data input through interface 202 is formatted to match a format required by selected model 206. The formatted data may be incorporated into a configuration file 208 and transmitted to model 206 for use during execution of model 206. In the exemplary embodiment, tool 204 executes on a PC-based computer 209 and configuration file 208 is transmitted to model 206 that executes on a Unix-based computer 210. Model 206 uses configuration file 208 and a database 212 containing engine related data to generate model results, which are transmitted to web interface 202 through PC-based computer 209.

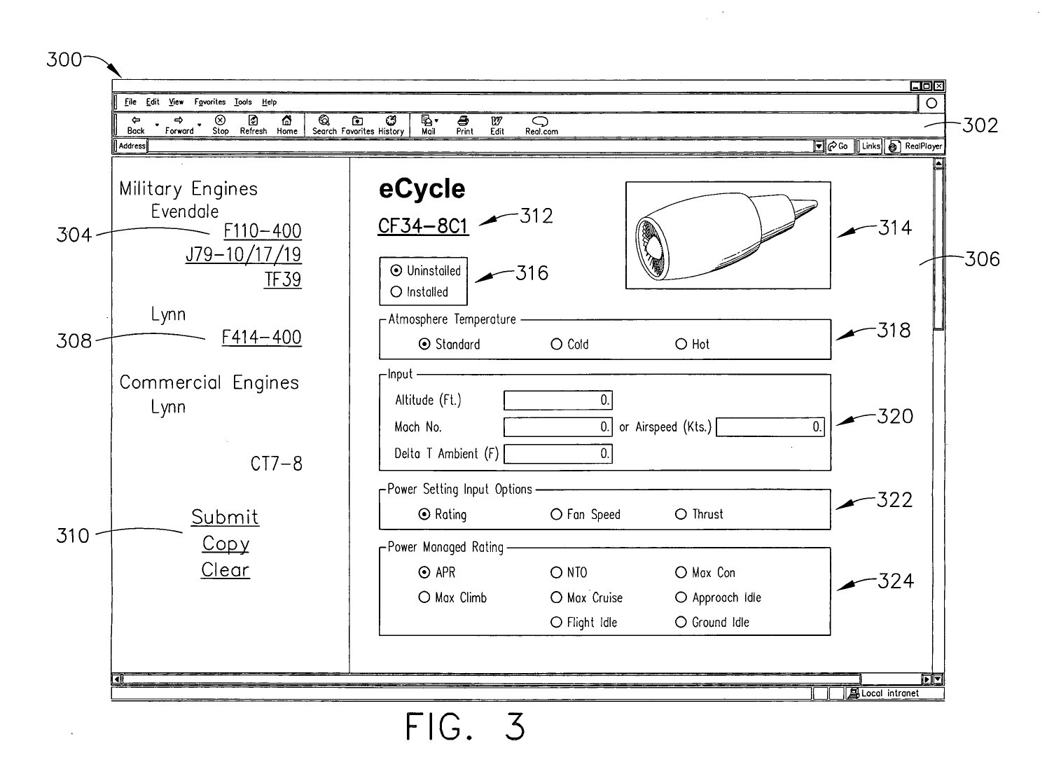

FIG. 3 is an example embodiment of a user interface 300 displaying an entry screen 302 for a web-based cycle model operation tool 204, such as eCycle. In the exemplary embodiment, entry screen 302 includes a frame portion 304 and a body portion 306. Frame portion 304 provides a user a selection of navigation options, such as an engine model selection area 308 and a command area 310. Engine model selection area 308 includes a listing of available engine models for a user to select. The listing of available engine models may be categorized and sorted according to a selectable characteristic, for example, engine use, engine fabrication location, and engine type. An example of an engine use characteristic may be whether the engine is used in military or commercial applications. A user may select an engine model for execution by selecting the displayed engine designation for the desired model.

Selection of a model causes the display in the body portion 306 to be updated to display preformatted data input fields that each correspond to data that is necessary for the selected model to execute to provide accurate results. At least some of the data fields also may include data that is not necessary for proper operation of the model, but may instead be used to identify the results from each instance of execution of the model. For example, a user identification and/or password may be required to be entered prior to execution of the model for administrative tracking and/or billing purposes. Such information may not affect the results of the execution of the model. In the exemplary embodiment, a CF34-8C1 engine model is selected for data entry. The selected engine designation is displayed in an engine field 312 and a graphic illustrated the selected engine may be displayed in an engine graphic field 314. Mimicking the selected engine designation and displaying a picture of the selected engine may facilitate correctly selecting a desired engine by the user. An engine operation field 316 may provide a selection for whether the engine is to be modeled as operating installed on an aircraft or installed in a test stand. An atmosphere temperature field 318 provides a selection for indicating a temperature operating profile to the model that the engine is to be simulated operating in. An input field 320 provides for input of an operating altitude, a speed, and an environmental temperature of the engine with respect to the temperature profile selected in atmosphere temperature field 318. A Power Setting Input Options field 322 provides an input entry field for prescribing the method used to set power level for the engine being simulated. For example, Power Setting Input Options field 322 may be set according to the engine rating, the engine fan speed, the engine thrust, or the engine power lever angle (PLA). A Power Managed Rating field 324 provides for an input entry for the Power Managed Rating during the simulation controlled by the selected model.

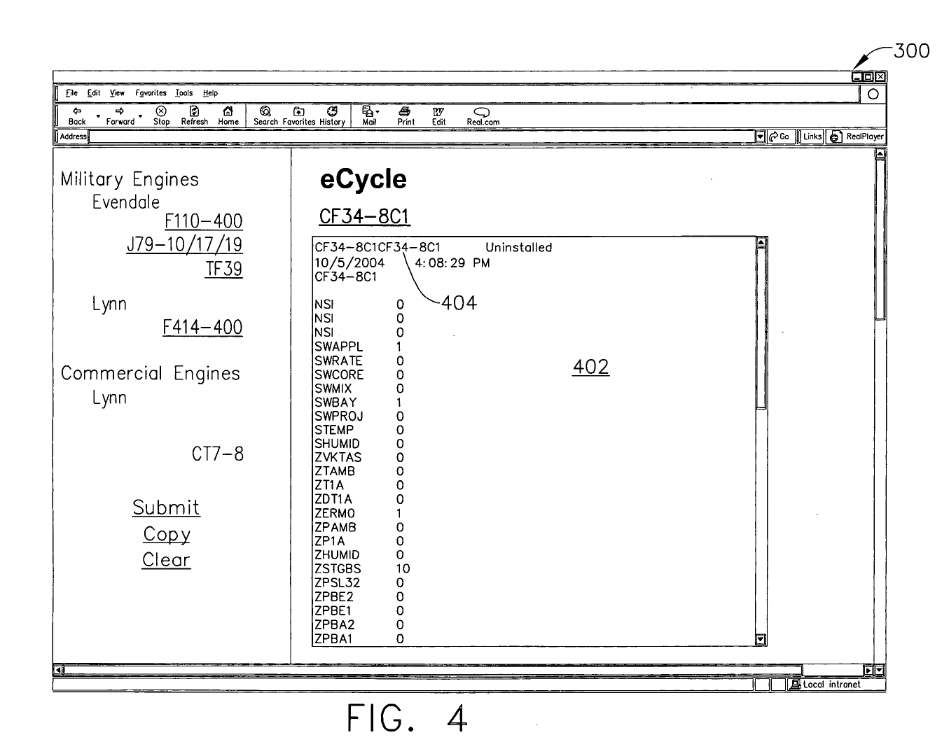

FIG. 4 is an example embodiment of user interface 300 (shown in FIG. 3) displaying input data that has been at least partially formatted for transmitting to model 206 in a display window 402. The input data may include a portion of the input data that is mimicked in display window 402, for example, the engine designation from engine field 312 is mimicked in display window 402. At least some data displayed in display window 402 is data that is determined based upon data entered in entry screen 302 and at least partially reformatted to a format corresponding to the selected model. Other data displayed in display window 402 may be administrative data, such as the current time and date.

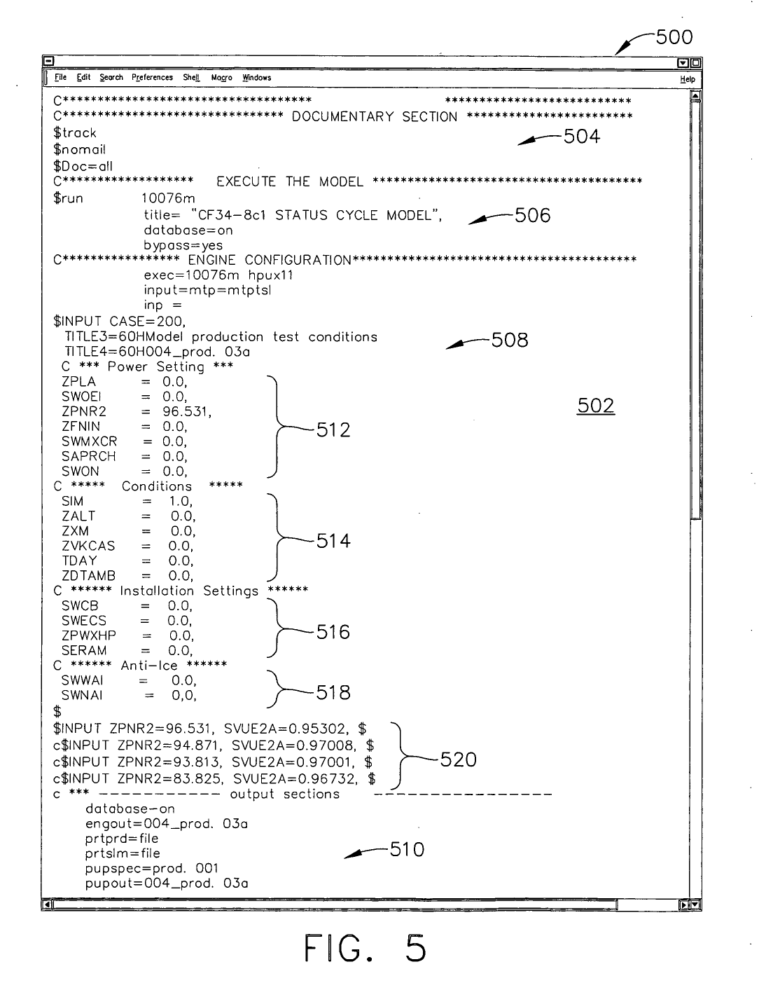

FIG. 5 is an example embodiment of a user interface 500 displaying a formatted data file 502 that includes a documentary section 504, a model execution section 506, an engine configuration section 508, and an output section 510. Documentary section 504 includes comments that may be used to inform a user of settings, features and characteristics that may be set differently than a normal or expected configuration. Model execution section 506 includes runtime parameters that are transmitted to model 206 at initiation of execution of model 206 to pass variable and constraint information to model 206. Engine configuration section 508 includes engine power settings 512 derived from input field 320, Power Setting Input Options field 322, and Power Managed Rating field 324. A conditions section 514 includes environmental conditions to be simulated during execution of model 206. An installation settings section 516 includes a condition of the engine during execution of model 206 and an anti-ice section 518 includes settings that depend on selected parameters input into tool 204. Input section 520 includes values for parameters that may be selected to vary during execution of the selected model 206. Additionally, Input section 520 may include information relating to multiple sequential executions of model 206 for automatically generating “what-if” scenario results. Output section 510 includes settings that control model 206 to define a format and output location for the results of execution of model 206.

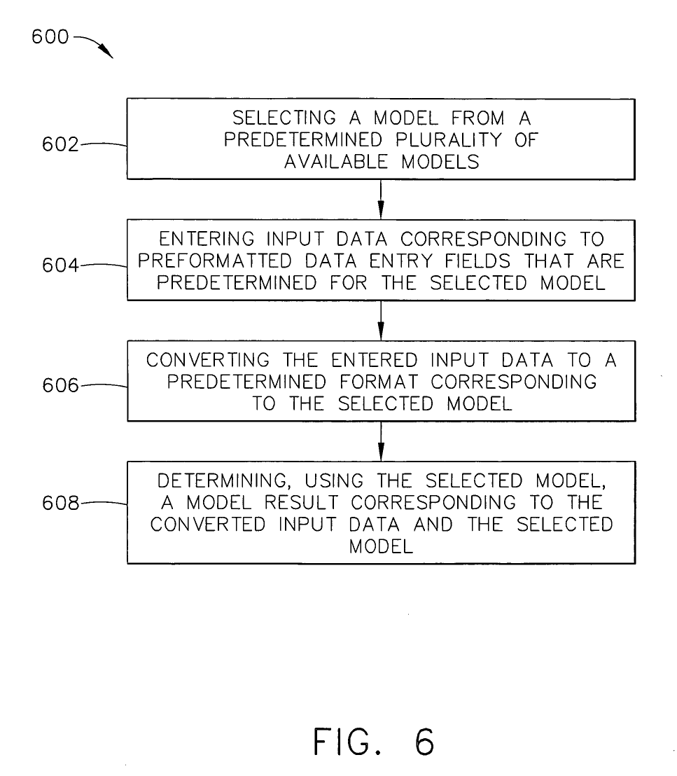

FIG. 6 is a flow chart of an exemplary computer-implemented method 600 of operating a calculational model. The method includes selecting 602 a model from a predetermined plurality of available models. In the exemplary embodiment, the models comprise cycle models for gas turbine engines. A software interface tool permits a relatively less experienced user to select an available model designed to simulate the operation of a gas turbine engine corresponding to the selected model. The user may then enter 604 input data corresponding to preformatted data entry fields that are predetermined for the selected model. The tool displays a screen that includes fields only for the input data required by the selected model. Limits associated with each field prevent the user from entering data that is inconsistent with the model selected and/or data that has been already input into the tool. The input data includes engine operating conditions such as environmental conditions to be simulated, control regimes that are to be implemented and a desired output format. The user may then submit the selected model for execution. The tool converts 606 the entered input data to a predetermined format corresponding to the selected model, transmits the data to the model and initiates execution of the model. The model determines 608 a model result corresponding to the converted input data and the selected model. The results may include process parameters for a plurality of locations within the simulated gas turbine engine, such as temperatures, pressures, and flows throughout the engine flowpath for each operational condition specified for the model. The results may be output to a file, printer, and/or display. In the exemplary embodiment, the tool executes on a PC-based computer accessible to the Internet. The tool transmits input data to a Unix-based computer that executes the selected model. The results of the model execution may be transmitted back to the PC-based computer for further processing, storing, and/or display.

A technical effect of the various embodiments of the invention is to permit a non-expert user of a plurality of cycle models to select a model from the plurality of models, input appropriate input data, operate the model, and obtain a result without specialized knowledge and/or experience with the engine being modeled or the model itself.

The various embodiments or components thereof may be implemented as part of a computer system. The computer system may include a computer, an input device, a display unit, and an interface, for example, for accessing the Internet. The computer may include a microprocessor. The microprocessor may be connected to a communication bus. The computer may also include a memory. The memory may include Random Access Memory (RAM) and Read Only Memory (ROM). The computer system further may include a storage device, which may be, but not limited to, a hard disk drive, a solid state drive, and/or a removable storage drive such as a floppy disk drive, or optical disk drive. The storage device can also be other similar means for loading computer programs or other instructions into the computer system.

As used herein, the term “computer” may include any processor-based or microprocessor-based system including systems using microcontrollers, reduced instruction set circuits (RISC), application specific integrated circuits (ASICs), logic circuits, and any other circuit or processor capable of executing the functions described herein. The above examples are exemplary only, and are thus not intended to limit in any way the definition and/or meaning of the term “computer”.

The computer system executes a set of instructions that are stored in one or more storage elements, in order to process input data. The storage elements may also hold data or other information as desired or needed. The storage element may be in the form of an information source or a physical memory element within the processing machine.

The set of instructions may include various commands that instruct the processing machine to perform specific operations such as the processes of the various embodiments of the invention. The set of instructions may be in the form of a software program. The software may be in various forms such as system software or application software. Further, the software may be in the form of a collection of separate programs, a program module within a larger program or a portion of a program module. The software also may include modular programming in the form of object-oriented programming. The processing of input data by the processing machine may be in response to user commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

While the present invention is described with reference to gas turbine engine thermodynamic cycle models, numerous other applications are contemplated. It is contemplated that the present invention may be applied to any set of computational modeling software.

The above-described systems and methods of capturing knowledge of a modeling expert in a modular, web-accessible, error-proofed form is cost-effective and highly reliable for managing a large number of complex models that include specific input data requirements applicable to each model. More specifically, the methods and systems described herein facilitate determining gas turbine engine process parameters for a plurality of conditions controlled by data input from a user. As a result, the methods and systems described herein facilitate gas turbine engine design and testing in a cost-effective and reliable manner.

Exemplary embodiments of engine cycle model operation tool systems and methods are described above in detail. The systems are not limited to the specific embodiments described herein, but rather, components of each system may be utilized independently and separately from other components described herein. Each system component can also be used in combination with other system components.

While the invention has been described in terms of various specific embodiments, those skilled in the art will recognize that the invention can be practiced with modification within the spirit and scope of the claims.

What is claimed is:

1. A computer-implemented method of operating a calculational model, said method comprising:
selecting a model from a predetermined plurality of available models;
entering input data corresponding to preformatted data entry fields that are predetermined for the selected model;
converting the entered input data to a predetermined format corresponding to the selected model; and
determining, using the selected model, a model result corresponding to the converted input data and the selected model.

2. A method in accordance with claim 1 wherein selecting a model from a predetermined plurality of available models comprises:
displaying a list of available models using a web-based graphical user interface (GUI);
prompting a user to select a listed model; and
displaying a preformatted data entry screen using the GUI having fields for entry of data corresponding to simulated operating conditions for the selected model.

3. A method in accordance with claim 1 wherein entering input data corresponding to preformatted data entry fields comprises entering gas turbine engine cycle input data corresponding to a desired gas turbine engine operating condition.

4. A method in accordance with claim 1 wherein entering input data corresponding to preformatted data entry fields comprises entering at least one of an installation status of a modeled engine, a temperature profile for engine operation, an operation environment setting, a power setting input option, and a power managed rating.

5. A method in accordance with claim 1 wherein converting the entered input data to a predetermined format corresponding to the selected model comprises:
receiving data in a first data entry format;
determining an input data specification for the selected model; and
converting the received data into a format corresponding to the selected model input data specification.

6. A method in accordance with claim 1 wherein converting the received data comprises converting the received data using a configuration file.

7. A method in accordance with claim 1 wherein determining, using the selected model, a model result corresponding to the converted input data and the selected model comprises:
retrieving from a database of gas turbine engine cycle data at least one of engine performance data, engine thermodynamic data, engine operation data and mathematical algorithms corresponding to the selected model;
executing the selected model using the retrieved data and the input data to generate results of the model execution that corresponds to a simulation of a gas turbine engine operation wherein the gas turbine engine is simulated by at least one of the retrieved data and the input data.

8. A calculational model operation tool comprising:
a user interface configured to display a preformatted data entry screen corresponding to user input selections, said user interface programmed to receive data input by a user; and
a processor programmed to format input data received from the user interface into a configuration format corresponding to a selected model, said processor further programmed to execute the selected model using the input data in the configuration format.

9. A tool in accordance with claim 8 wherein said user interface comprises a web-based interface.

10. A tool in accordance with claim 8 wherein said processor programmed to format input data comprises a PC-based computer.

11. A tool in accordance with claim 8 wherein said processor programmed to execute the selected model comprises a UNIX-based computer.

12. A tool in accordance with claim 11 wherein said processor programmed execute the selected model comprises a database of gas turbine engine cycle data including at least one of engine performance data, engine thermodynamic data, and engine operation data.

13. A tool in accordance with claim 11 wherein said processor programmed to execute the selected model is programmed to conditionally execute the selected model based on the input data and the selected model input requirements.

14. A computer program embodied on a computer readable medium for operating a calculational model using a server system coupled to a client system and a database, the client system including a user interface, said program comprising a code segment that prompts a user to select at least one model and then:
selects a model from a predetermined plurality of available models;
receives input data corresponding to preformatted data entry fields that are predetermined for the selected model;
converts the entered input data to a predetermined format corresponding to the selected model; and
determines, using the selected model, a model result corresponding to the converted input data and the selected model.

15. A computer program in accordance with claim 14 comprising a code segment that:
displays a list of available models using a web-based graphical user interface (GUI);
prompts a user to select a listed model; and
displays a preformatted data entry screen using the GUI having fields for entry of data corresponding to simulated operating conditions for the selected model.

16. A computer program in accordance with claim 14 comprising a code segment that enters gas turbine engine cycle input data corresponding to a desired gas turbine engine operating condition.

17. A computer program in accordance with claim 14 comprising a code segment that enters at least one of an installation status of a modeled engine, a temperature profile for engine operation, an operation environment setting, a power setting input option, and a power managed rating.

18. A computer program in accordance with claim 14 comprising a code segment that:
receives data in a first data entry format;
determines an input data specification for the selected model; and
converts the received data into a format corresponding to the selected model input data specification.

19. A computer program in accordance with claim 14 comprising a code segment that converts the received data using a configuration file.

20. A computer program in accordance with claim 14 comprising a code segment that:
retrieves from a database of gas turbine engine cycle data at least one of engine performance data, engine thermodynamic data, engine operation data and mathematical algorithms corresponding to the selected model; and
executes the selected model using the retrieved data and the input data to generate results of the model execution that corresponds to a simulation of a gas turbine engine operation wherein the gas turbine engine is simulated by at least one of the retrieved data and the input data.
